(19) United States
(12) Patent Application Publication
(10) Pub. No.: US 2012/0143654 A1
(43) Pub. Date: Jun. 7, 2012

(54) DYNAMIC ETHICAL COMPLIANCE MONITORING OF VENDORS, SUPPLIERS AND AGENTS

(75) Inventors: David R. Childers, Lake Oswego, OR (US); Charles Jennings, Portland, OR (US)

(73) Assignee: EthicsPoint, Inc., Lake Oswego, OR (US)

(21) Appl. No.: 13/310,617

(22) Filed: Dec. 2, 2011

Related U.S. Application Data
(60) Provisional application No. 61/419,131, filed on Dec. 2, 2010.

(51) Int. Cl. G06Q 10/06; G06Q 10/08

(52) U.S. Cl. 705/7.39

(57) ABSTRACT

Systems and methods for compliance monitoring are described. An example system includes a sourcing organization, a VSA entity having policies governing conduct, and a compliance entity in communication with the sourcing organization and the VSA entity. The compliance entity has the policies of the VSA and further has self-disclosure information from the VSA entity regarding compliance with its policies. The compliance entity provides access to the policies and the self-disclosure information to the sourcing organization over an electronic communication medium. The compliance entity may further provide the VSA entity with a demarcation of compliance based at least in part on the VSAs compliance with its policies.

### CROSS-REFERENCE TO RELATED APPLICATION

This application claims the benefit of provisional application No. 61/419,131, filed Dec. 2, 2010. This application is incorporated by reference herein in its entirety and for all purposes.

### FIELD OF THE INVENTION

The invention relates generally to online service, and more specifically, an online service for supporting global sourcing and supply chain activities.

### BACKGROUND OF THE INVENTION

Public and private organizations of all kinds today rely increasingly on a global network of suppliers, vendors and agents (collectively, VSAs). These VSAs provide everything from raw materials, to finished goods, to specialized services in support of organizational systems. They also operate in widely varied political and cultural environments. Consequently, purchasers of their products/services often find that the ethical standards and practices of VSAs can conflict with their own ethical standards and practices, and complicate or compromise both internal governance and external regulatory compliance. Consequently, great care must be taken by purchasers of VSA goods and services to make certain that their own policies are not being violated because of their VSA relationships.

Monitoring the ethical policies and practices of global VSAs is a fairly common activity, but historically it has been conducted by the organization doing the purchasing (or, to a limited degree, by trade associations).

There are several problems with this traditional approach:

It is wasteful. Organizations working with the same VSAs repeat similar and unnecessarily redundant activities. Considerable economies of collaboration can be achieved by using a common, independent service supporting many organizations.

It is reactive. Nearly all in-depth monitoring of the ethical compliance of VSAs after an initial engagement comes as the result of a specific incident or report. Investigations come after the fact, and business intelligence that would help prevent ethical compliance incidents in the first place is rare and incomplete.

It is static. Global sourcing departments at large companies may have databases of information on their VSAs, but they often contain little or no information of value with respect to these VSAs' ongoing ethical practices, and even if they do, this information is often out of date.

It is buried. Even if up-to-date ethical compliance information about VSAs is kept by the sourcing organization, it is often inaccessible to the people in the organization who need it most—the people on the ground, around the world, working directly with VSAs.

Consequently, there is a need for a trusted VSA ethical monitoring service which assists sourcing organizations in meeting and maintaining their own internal governance, risk and compliance standards and policies, when engaging in global supply chain activities.

### BRIEF DESCRIPTION OF THE DRAWINGS

FIG. 1 is a graphical representation of categories of information provided by a compliance monitoring system according to an embodiment of the invention.

FIG. 2 is a graphical representation of various functional components of an information architecture according to an embodiment of the invention.

FIG. 3 is a simplified block diagram of a compliance monitoring system according to an embodiment of the invention.

FIG. 4 is a graphical representation of a compliance monitoring cycle according to an embodiment of the invention.

FIG. 5 is a graphical representation of a hierarchy of links to various information according to an embodiment of the invention.

FIG. 6 is a graphical representation of examples of public and confidential information according to an embodiment of the invention.

### DETAILED DESCRIPTION

Certain details are set forth below to provide a sufficient understanding of embodiments of the invention. However, it will be clear to one skilled in the art that embodiments of the invention may be practiced without these particular details. Moreover, the particular embodiments of the present invention described herein are provided by way of example and should not be used to limit the scope of the invention to these particular embodiments. In other instances, well-known circuits, control signals, timing protocols, and software operations have not been shown in detail in order to avoid unnecessarily obscuring the invention.

The present invention includes examples that deliver an independent, managed service solution to the problem of VSA ethical compliance monitoring. It uses a variety of components and is organized to provide an economic, proactive, dynamic, easily accessible online service. This service also includes several processes for evaluating and monitoring the ethical compliance standards, practices and performance of VSAs. Various components and holistic processes that may be used with the invention are described. For example, the components may include Real Time Awareness (RTA) systems for ethical monitoring, a trust SEAL showing real-time compliance status, and contractual-based VSA ethical transparency. Examples of processes include VSA Trust Management and SEAL Compliance Monitoring Cycle. The individual components and the overall processes may assist sourcing organizations and their global VSA partners leverage technologies and methodologies in order to improve ethical standards and policy compliance throughout global supply chains.

Kope's U.S. Pat. No. 5,765,138 (1998), regarding interactive evaluation of potential vendors, describes CD-ROM and controlled database access to vendor “maturation and quality” data. The Kope patent, however, does not describe any specialized focus on ethical compliance monitoring.

Various examples of the invention provide global sourcing decision-makers with up-to-the-minute information, from thousands of potential sources. In some examples, a modern information technology platform is leveraged with Internet-centric systems. These systems can be accessed and used for specific ethical compliance monitoring purposes by any device with a browser, including smart phones. Additionally, examples of the invention may include use of a “trustmark” seal which is used in various ways to help sourcing organizations obtain ready access to a VSA's policies, practices and status as a trusted partner.

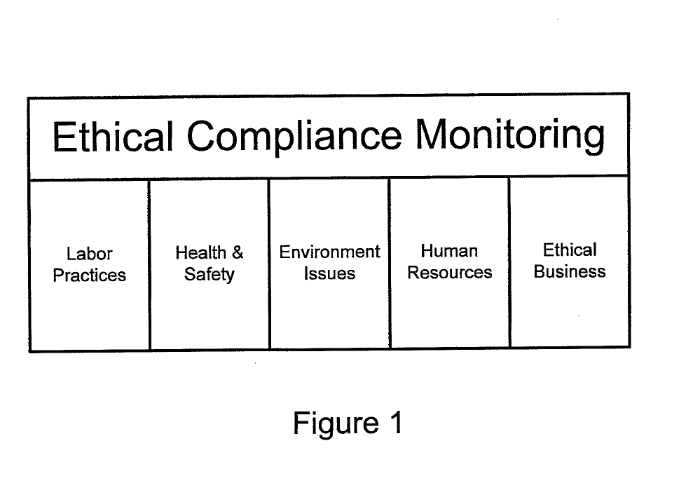

The invention includes examples of a dynamic ethical compliance monitoring system that delivers information that consists of both long-term (static) and real-time (dynamic) intelligence about the ethical practices of their VSAs. As illustrated in FIG. 1, the information may be segmented according to key functional activities, including: labor practices; health and safety; environmental sustainability and regulatory compliance; human resource management; and ethical business practices.

Information about VSAs in these five areas is obtained not merely by calls to a single database; rather, the information may be dynamically aggregated and delivered in the form of a stateless, hyper-connected data “swarm” of information sources and data types from around the world. Some of this data is freely accessible to everyone on the public Internet; other sections are privately managed (and carefully protected) through trusted computing access controls. Information may also be obtained through investigations. These technology controls are governed under the terms and conditions of legal contracts between and among the various parties using the service.

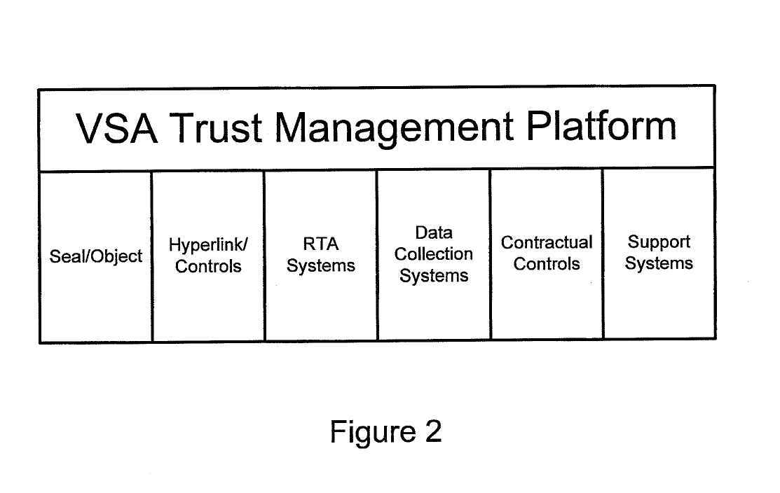

Information in the system may be managed with an information architecture called a VSA Trust Management Platform. In an example platform, the information architecture is based on the following functional components (FIG. 2):

a) An online digital object, designed as a kind of “seal of approval”, for display on VSA web sites, for example, a “trustmark” which can be displayed on the VSA web site. This seal/object (hereinafter SEAL) is designed specifically to meet the needs of both VSAs and their purchasing partners.

b) Hyperlinks and controls, enabling access to various data sets providing important information about the VSA displaying the seal.

c) Various Real Time Awareness (RTA) systems designed to search for and collect information, globally, about the ethical compliance status of the VSA.

d) A legal contract, providing the right to display the SEAL, between the seal-issuing company (hereinafter, the HOST) and the VSA.

e) Various direct self-disclosure information collection processes on the part of the VSA, on behalf of the HOST—with all such activities governed by the contract between the HOST and the VSA.

f) Support systems for sourcing organizations, especially with respect to global ethical compliance management, across multiple VSAs, and utilizing both the online SEAL and related data hierarchies, and the contractual controls enabled by the HOST's contract with the VSA.

The above components can function together to increase the transparency of VSAs' policies, practices and reputations. Information in these subject areas is made available to organizations that purchase VSA goods and services.

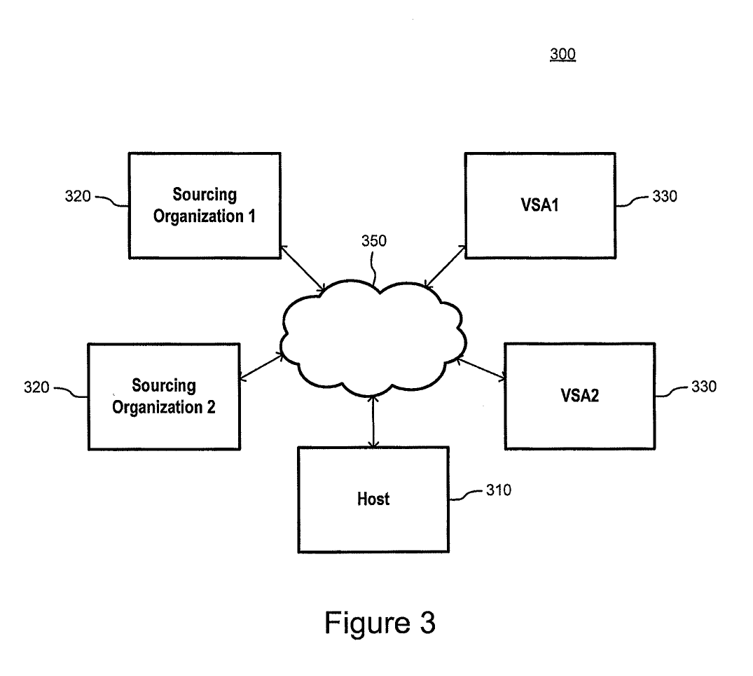

FIG. 3 illustrates a system 300 according to an example of the invention. The system 300 includes a HOST system 310, and further includes Sourcing Organizations 320 and VSAs 330 in communication with one another over a network 350. The network 350 may be, for example, a computer network having wired, wireless, or cellular components, or combinations thereof. As will be described in more detail below, the HOST 310 authorized Sourcing Organizations 320 obtain access to information regarding the VSAs 330, which may include the VSA's own self-disclosed policies and practices. This enables the HOST to monitor the VSA with respect to compliance with terms of the HOST/VSA contract—thereby enabling the HOST to stay current with VSA activities and the Sourcing Organizations to monitor VSA compliance as well.

In some examples of the invention, the HOST includes components that are executed by processing hardware and/or software to provide compliance monitoring. The HOST system 310 may be implemented using conventional hardware technologies, software technologies, or combinations thereof. For example, the HOST system 310 may be include conventional database technologies for storing information as electronic data and may further include conventional processing and communication hardware and software to provide compliance monitoring as described. Similarly, the HOST system 310 may be accessed by the VSAs 330 and Sourcing Organizations 320 utilizing hardware, software, or combinations thereof now known or later developed.

Examples of the invention may also include a SEAL Compliance Monitoring Cycle process for achieving optimal levels of VSA ethical transparency. The goal of such monitoring is to help sourcing organizations make better decisions and improve overall governance, risk, and compliance management; and help VSAs to promote their best policies and best practices to these same sourcing organizations.

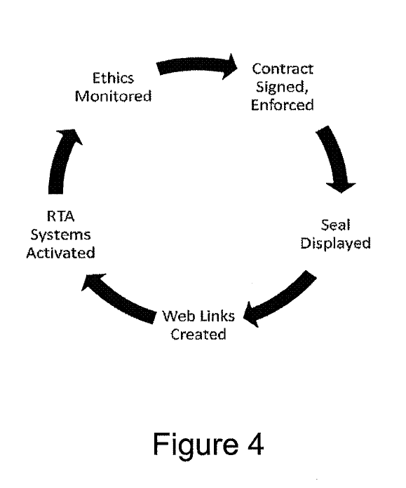

The SEAL Compliance Monitoring Cycle (FIG. 4) begins with a VSA contracting with the HOST for the right to display the seal/object on the VSA's website. A contract is then negotiated which:

(a) Provides the right to display the seal/object, under policies and practices governed by the contract.

(b) Requires certain assertions regarding VSA self-disclosure, essentially requiring VSAs to disclose and adhere to their own publicly disclosed ethical policies and practices, or face adverse consequences under the contract.

(c) Provides HOST with the right to obtain and display certain data about the VSA in the former's online SEAL data hierarchy.

(d) Allows HOST to make the data provided under item c) above available to sourcing organizations, through both open and proprietary access.

Once the contract is executed, the seal is publicly displayed on the VSA Web site. The SEAL is a Web “trustmark” that certifies active participation as a member of good standing in the HOST's ethical compliance monitoring program. It may also be a small Web application that executes in the client browser, in order to authenticate its validity and prevent spoofing, and open navigational windows that provide access to various kinds of data about the organization displaying the seal. Access to these data by sourcing organizations is controlled by the trusted-third-party HOST, not the VSA.

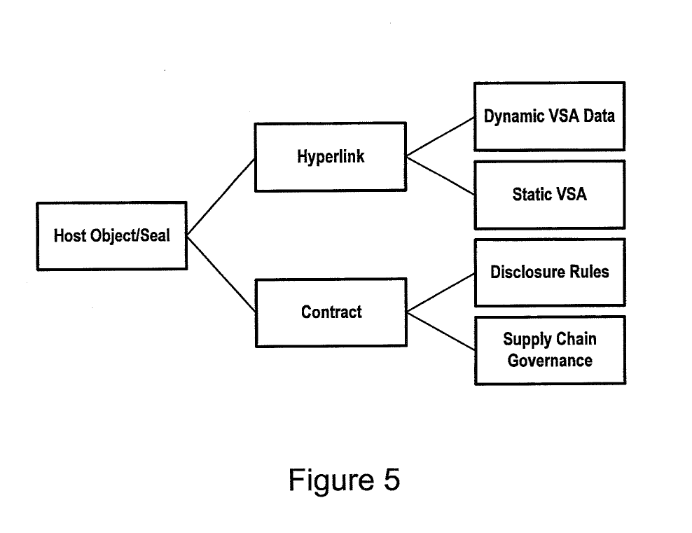

In some examples, various hyperlinks are embedded in the seal (FIG. 5), employing Document Object Model (DOM) and other client-side controls that operate in all common browsers. These hyperlinks may be both hierarchically and semantically connected to a series of web pages, widgets and controls (hereinafter, RTA systems) which together provide a current, transparent view of the VSA, its practices, and its reputation.

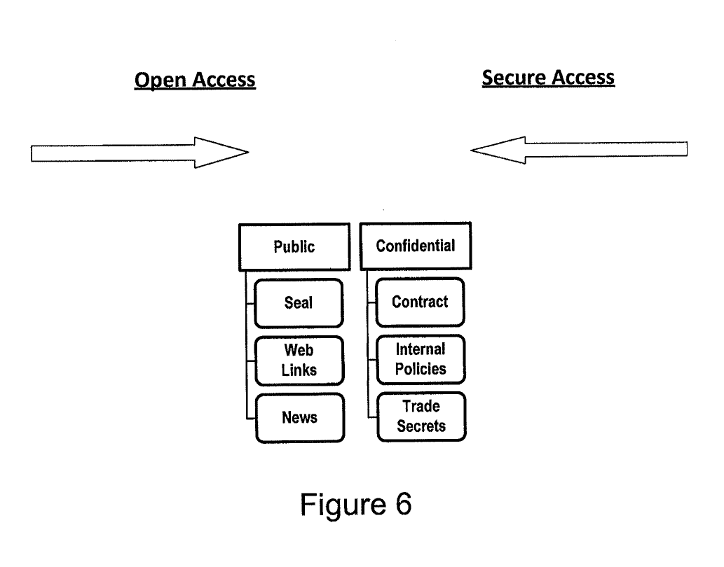

The RTA systems can leverage existing and future Web services technology from many sources. Dynamic real-time or near real-time data from a wide variety of sources, both public and proprietary, is fused into an easily accessible visualization service designed specifically for the purpose of VSA compliance monitoring (FIG. 6). Information regarding the VSA may also be obtained from investigations as well.

Static VSA data is also fused into the service, thus creating a holistic view of the VSA that contains both traditional standard ethical compliance data and metrics, and new dynamic, real-time information from sources around the globe.

In some embodiments, the compliance monitoring system includes a variable VSA compliance weighting mechanism, in which the internal policies of an acquirer of VSA services are used to give priority to certain VSA compliance elements over others (e.g., labor practices over environmental regulation compliance). Additionally, when such priority weightings are rendered visible and are configurable in a reader application, an acquirer of VSA services can dynamically adjust the weighting values related to viewing VSA compliance policies and attributes.

Once this service is in place, both the HOST and authorized sourcing organizations obtain access to the information it contains. This information, which includes the VSA's own self-disclosed policies and practices, enables the HOST to monitor the VSA with respect to compliance with terms of the HOST/VSA contract—thereby enabling the HOST to stay current with VSA activities, and enabling the VSA to continue displaying the HOST's seal.

Included as part of the description is Appendix A, Supply Chain Risk/Compliance Monitoring, written by Charles Jennings, which may be incorporated by reference for supporting any examples of the invention.

In various examples of the invention, several benefits may be provided, for example:

Increased transparency and accountability in the management and operation of global supply chains;

Improved business intelligence about the ethical practices of VSA partners;

Better, easier access to important information about VSAs' ethical policies, and their practices in the real-world;

Smarter, faster, less risky supply chain decisions by sourcing organizations;

Capacity to bring new levels of trust and accountability into supply chain relationships;

Faster VSA evaluation cycles by purchasers;

Lower governance, risk and compliance expense for certain global sourcing and supply chain operations (since the cost of the HOST's service is amortized across multiple customers);

Increased visibility and credibility for global VSAs who maintain high ethical standards.

Integration of new Web service capabilities into a dynamic, network-layer information management system, capable of consuming dynamic information, and responding flexibly to both changing regulatory environments and ever evolving individual user needs and preferences.

Ability of the systems to consume, store, process, fuse and disseminate various ethical compliance data from many sources—ranging from open source public information feeds to proprietary commercial data, as well as investigations.

Ability to display all system information in a series of consolidated or hyperlinked views, with access controls for these views divided into two categories:

Open, public access via the Internet;

High assurance access using contextually appropriate Authentication, Authorization, Audit security controls.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A system for monitoring compliance, comprising:
a sourcing organization;
a VSA entity having policies governing conduct by the VSA entity; and
a compliance entity in communication with the sourcing organization and the VSA entity, the compliance entity having the policies of the VSA and further having at least self-disclosure information from or about the VSA entity regarding compliance with its policies, and the compliance entity providing access thereto by the sourcing organization over an electronic communication medium.

2. The system for monitoring compliance of claim 1 wherein the compliance entity further provides the VSA entity with a demarcation of compliance status based at least in part on the VSAs compliance with the policies.

3. The system for monitoring compliance of claim 2 wherein the demarcation of compliance includes links to access the policies of the VSA, the self-disclosure information from the VSA, or combinations thereof.

4. The system for monitoring compliance of claim 1 wherein the compliance entity further collects data regarding the VSA entity from proprietary sources, investigations, public sources, or combinations thereof.

5. The system for monitoring compliance of claim 4 wherein the data collected by the compliance entity comprises dynamic real-time data, near real-time data, or combinations thereof.

6. The system for monitoring compliance of claim 5 wherein the collected data comprises at least information on one of labor practices, health and safety, environmental sustainability and regulatory compliance, human resource management, and ethical business practices.

7. The system for monitoring compliance of claim 1, further comprising a computer network over which the sourcing organization, VSA entity, and compliance entity communicate.

8. A method of monitoring compliance of a VSA, comprising:
obtaining policies from the VSA governing its behavior;
collecting information from the VSA regarding its compliance with the policies;
providing the VSA with a seal of compliance based at least in part on the information collected from the VSA and the policies; and
providing electronic access to the policies and collected information from the VSA to sourcing organizations.

9. The method of claim 8 wherein the seal of compliance comprises a trustmark.

10. The method of claim 8, further comprising linking from the seal of compliance to the policies of the VSA and collected information to provide access thereto.

11. The method of claim 8 wherein the seal of compliance comprises a Web application.

12. The method of claim 8, further comprising collecting information regarding the VSA from public sources, proprietary sources, investigations, or combinations thereof.

13. The method of claim 12 wherein the information collected comprises dynamic real-time data, near real-time data, or combinations thereof.

14. The method of claim 8, further comprising requiring the VSA to comply with the policies and self-disclose information supporting the compliance for providing the VSA with the seal of compliance.

15. The method of claim 8 wherein access to the policies and collected information from the VSA is controlled by a party separate from the VSA and sourcing organizations.

16. A compliance monitoring system, comprising:
electronic data storage configured to store information as electronic data;
a policy component operable to receive policies for a VSA and to store the policies as data in the data storage, the policies governing conduct by the VSA;
a VSA information component operable to receive information regarding the VSA and to store the information as data in the data storage, the information regarding the conduct of the VSA;
a compliance component operable to provide access to the policies and VSA information to sourcing organizations and a host of the system for compliance monitoring; and
a processor configured to execute the components and provide compliance monitoring based at least in part on the VSA rules and self-disclosed information.

17. The compliance monitoring system of claim 16 wherein the information component comprises a self-disclosure component operable to receive information from the VSA regarding compliance with the policies.

18. The compliance monitoring system of claim 16 wherein the information component comprises a real-time information component operable to search for and collect information about the ethical compliance with status of the VSA.

19. The compliance monitoring system of claim 16 wherein the information component is operable to dynamically aggregate and deliver information in the form of a stateless, hyper-connected data swarm of information sources and data types.

20. The compliance monitoring system of claim 16, further comprising a communication component operable to communicate with the VSA and sourcing organization through a computer network.

21. The compliance monitoring system of claim 16 wherein the compliance component comprises a compliance demarcation component operable to receive access requests to the information regarding compliance of the VSA to the policies from a compliance demarcation displayed by the VSA, the compliance demarcation provided to the VSA when information from the VSA is provided to the host according to rules governing a relationship between the VSA and a host of the system.

22. The compliance monitoring system of claim 16, further comprising a variable VSA compliance weighting mechanism, in which the internal policies of an acquirer of VSA services are used to give priority to certain VSA compliance elements over others, and further, when such priority weightings are rendered visible and are configurable in the reader application, so that an acquirer of VSA services can dynamically adjust the weighting values related to viewing VSA compliance policies and attributes.
